(19) United States
(12) Patent Application Publication
(10) Pub. No.: US 2007/0189219 A1
(43) Pub. Date: Aug. 16, 2007

(54) Internet protocol tunneling on a mobile network

(76) Inventors: Mruthyunjaya Navali, Westford, MA (US); Kuntal Chowdhury, Plano, TX (US); Sanil Kumar Puthiyandyil, Nashua, NH (US); Matthew H. Harper, Salem, NH (US)

Correspondence Address: WILMER CUTLER PICKERING HALE AND DORR LLP, 399 PARK AVENUE, NEW YORK, NY, 10022, US

(21) Appl. No.: 11/598,875

(22) Filed: Nov. 14, 2006

Related U.S. Application Data
(60) Provisional application No. 60/738,503, filed on Nov. 21, 2005.

(51) Int. Cl. H04Q 7/00

(52) U.S. Cl. 370/331

(57) ABSTRACT

Systems and methods are provided for sending information in a first protocol over a network that supports a second protocol. A tunnel is used to provide a roaming mobile node with IPv6 packet data over an IPv4 core network. When the mobile node is handed off while roaming, the same IP address is provided to the mobile node and the IPv6 packet data is again tunneled over the IPv4 core network. Certain embodiments allow an IPv4 core network to support a mobile node that uses Simple IPv6 or MIPv6 addressing. This system and method can be applicable to situations where the mobile node uses addressing greater than 32 bits, while the core network supports 32 bit addressing.

### CROSS-REFERENCE TO RELATED APPLICATIONS

This application claims benefit of U.S. Provisional Patent Application No. 60/738,503, filed Nov. 21, 2005, which is hereby incorporated by reference herein in its entirety.

### TECHNICAL FIELD OF THE INVENTION

The present invention relates to a system and method of communicating information in a first protocol over a network that supports a second protocol. More particularly, a dynamic tunnel is used to communicate information in a second protocol over a network designed for a first protocol, while also providing address mobility.

### BACKGROUND OF THE INVENTION

Internet protocol (IP) is a protocol for communicating data across a packet switched network. The network can include wireless and wire-line portions between a first and a second node. IP provides a unique global addressing method for representing the location of nodes in the network. This allows a first node to send data to a second node by using the IP address of the second node when sending the data. Internet Protocol version 4 (IPv4) uses 32-bit (4-byte) addresses, which limits the address space to 4,294,967,296 possible unique addresses. The next generation IP is IPv6, which supports a larger address space: addresses in IPv6 are 128 bits long versus 32 bits in IPv4.

Networking equipment that support IPv4 addresses cannot easily read and route packets based on IPv6 addresses given the differences in length. Thus, an IPv6 message cannot generally be sent over a network that only supports IPv4 given the differences in addressing. This creates a problem for transitioning networks from IPv4 to IPv6 because it can be very expensive to replace networking equipment in order to upgrade the addressing support.

### SUMMARY OF THE INVENTION

Systems and methods are provided for communicating packet data that is in a first protocol over a network core that supports a second protocol. The packet data is communicated through a dynamic tunnel that also allows a mobile node to maintain the same address while roaming on the network. In some embodiments, the mobile node communicates with a packet data serving node in IPv6 or MIPv6 and the network core between the routing device and a home agent is an IPv4 network. A bi-directional tunnels provides communication in IPv6 or MIPv6 over the IPv4 network.

Certain embodiments feature a system providing a packet data communication system featuring a packet data serving node (PDSN) that communicates with a mobile node using a first protocol; a network core that is coupled to the packet data serving node that uses a second protocol; a home agent (HA) that is coupled to the network core, wherein a tunnel is established between the PDSN and the HA to carry encapsulated data packets using the first protocol over the network core; and a second PDSN coupled to the network core, wherein the mobile node maintains the same address when the mobile node moves from the PDSN to the second PDSN.

Some embodiments feature a packet data communication method featuring assigning an address to a mobile node; establishing a tunnel from a packet data serving node (PDSN) to a home agent to exchange packet data in a first protocol over a network core that uses a second protocol; assigning the same address to the mobile node when the mobile node moves to a second PDSN and a handoff from the PDSN to the second PDSN occurs; and establishing the tunnel from the second packet data serving node to the home agent to exchange packet data.

Certain embodiments feature a system providing a packet data communication system featuring a mechanism for communicating with a mobile node using a first protocol; a network core that is coupled to the mechanism for communicating that uses a second protocol; a mechanism for providing home routing that is coupled to the network core, wherein a tunnel is established between the mechanism for communicating and the mechanism for providing home routing to carry encapsulated data packets using the first protocol over the network core; and a second mechanism for communicating coupled to the network core, wherein the mobile node maintains the same address when the mobile node moves from the mechanism for communicating to the second mechanism for communicating.

### BRIEF DESCRIPTION OF THE DRAWINGS

FIG. 1 is a schematic diagram of a network using a tunnel to send traffic over the network in accordance with certain embodiments of the invention;

FIG. 2 is a diagram that illustrates a process for setting up a tunnel in accordance with certain embodiments of the invention;

FIG. 3 is a schematic signaling diagram setting up a tunnel using a unique identifier in accordance with certain embodiments of the invention;

FIG. 4 is a schematic signaling diagram setting up a tunnel using a shared identifier in accordance with certain embodiments of the invention;

FIG. 5 is a schematic signaling diagram of an inter-PDSN handoff in accordance with certain embodiments of the invention;

FIG. 6 is a diagram of a request extension in accordance with certain embodiments of the invention; and

FIG. 7 is a diagram of an address extension in accordance with certain embodiments of the invention.

### DETAILED DESCRIPTION OF THE INVENTION

In certain embodiments of the invention, a tunnel is used to send information that was sent in a first protocol over a network that supports a second protocol. A network device is used to encapsulate the information in the first protocol at one end of the network into the second protocol for transmission. Another network device receives the encapsulated information and removes the encapsulation to transmit the information based on the first protocol. The encapsulation can place the packet using the first protocol into the payload of a packet using the second protocol or appending a header configured for the second protocol to the packet using the first protocol. For example, in the absence of native Internet Protocol version 6 (IPv6) support on an IPv4 packet core network, a transition mechanism can be used to provide IPv6 address space over an existing IPv4 packet core network in some embodiments of the invention.

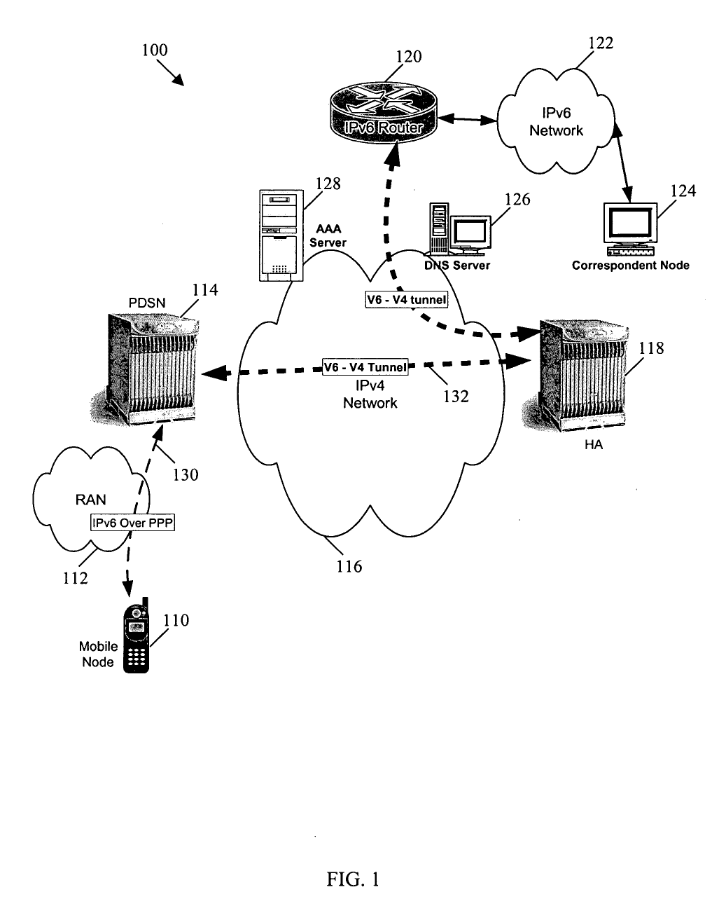

FIG. 1 illustrates a network 100 using a tunnel to send traffic over a network in accordance with certain embodiments of the invention. Network 100 includes a mobile node 110, a radio access network (RAN) 112, a packet data serving node (PDSN) 114, an IPv4 network 116, a home agent 118, a router 120, an IPv6 network 122, a correspondent node 124, a domain name service (DNS) server 126, and an authentication, authorization, and accounting (AAA) server 128. Mobile node 110 can be a cell phone, a personal digital assistant (PDA), or any other data-capable wireless device such as a Blackberry, a Treo, or a laptop computer with a wireless card. RAN 112 includes a base station (not shown) to transmit to mobile node 110 over radio frequencies as well as other network devices to process packet data for radio frequency transmission. PDSN 114 serves as a connection point between the radio access network and the packet data network and is responsible for the establishment, maintenance, and termination of point-to-point (PPP) sessions with mobile node 110. HA 118 routes data to and from a mobile node attached to a foreign network and provides a home address for sending information to and receiving information from the mobile node.

Router 120 is a router that is found in telecommunication networks and can forward packets based on an address. Router 120 is in communication with IPv6 network 122, which includes other routers and network devices. Illustrated IPv6 network 122 is in communication with correspondent node 124. Correspondent node 124 can be, for example, a web server, a content provider, a device containing a radio frequency identification (RFID) tag, another mobile node, or a computer. DNS server 126 provides domain name service to locate IP addresses from other information such as an email address or a universal relay link. AAA server 128 provides monitoring of a mobile node's activity for billing purposes and grants access to network resources after verifying the user.

In network 100, mobile node 110, which is IPv6 capable, establishes a PPP link 130 with PDSN 114. PDSN 114 can provide IPv6 routing for mobile node 110 and provide information to mobile node 110 to establish a network connection. The network connection can be a stateless auto-configuration. PDSN 114 can communicate with mobile node 110 using IPv6 packets. PDSN 114 communicates to HA 118 over an IPv4 network through a V6-V4 tunnel 132. Illustrated V6-V4 tunnel 132 handles IPv6 packets received from mobile node 110 so that the IPv6 packets can be communicated over an IPv4 network. Because a mobile node can roam and sessions can be initiated or discontinued, V6-V4 tunnel 132 is dynamic in some embodiments. This dynamic aspect provides flexibility in establishing sessions and traffic flows for mobile node 110, and allows creation of one or more tunnels 132 when needed for one or more mobile nodes. In some embodiments, proxy mobile IP (PMIP) can be used to establish V6-V4 tunnel 132. PMIP is similar to Mobile IP (MIP), except that the MIP client is in the network instead of being a mobile node.

In certain embodiments, PMIP supports tunneling Simple IPv6 traffic from PDSN 114 to a correspondent node 124 via HA 118 and over an IPv4 network 116 and an IPv6 network 122. MIP messages are used to obtain an IPv6 prefix from HA 118 to assign mobile node 110. This prefix allows mobile node 110 to create an IPv6 address and allows PDSN 114 to route packet data over an IPv4 network. In some embodiments, the prefix is stored by HA 118 and sent to PDSN 114 when a mobile node requests a session. The same prefix can be sent again after a handoff. An IPv4 Care of Address (CoA) along with a HA IPv4 address and an IPv6 prefix or address can be used to setup an IPv6-in-IPv4 tunnel. The IPv4 addresses provide routing over the IPv4 network, while the prefix provides routing outside the IPv4 network. The IPv6 address can be associated with IPv4 addresses such as the HA IPv4 and the PDSN IPv4 for the purpose of tunneling packet data. After the IPv6-in-IPv4 tunnel is setup, the IPv6 packet data can be encapsulated in an IPv4 packet for transmission over the IPv4 network. The dynamic nature of the IPv6-in-IPv4 tunnel allows the tunnel to move from PDSN to PDSN to follow a roaming mobile node because on handoff the PDSN registers the same IPv6 prefix with the HA each time with a different IPv4 CoA.

In some embodiments, tunnel setup occurs when acquiring a prefix from the home agent using PMIP. The tunnel endpoints can be the addresses of a foreign agent and a home agent. Packets of a first protocol from communication with the mobile node are tunneled at the PDSN over the network core, which is setup for a second protocol.

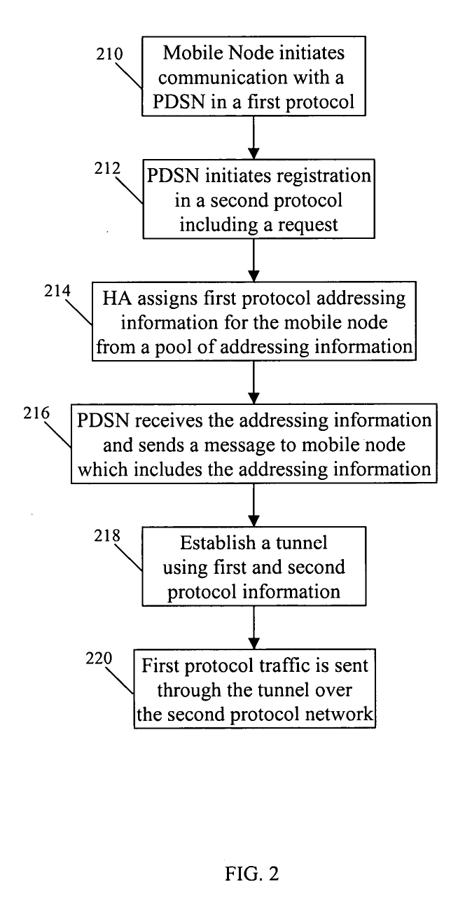

FIG. 2 illustrates the process for setting up a tunnel for first protocol communication (e.g., IPv6) over a second protocol network (e.g., IPv4) in accordance with some embodiments of the invention. At step 210, a mobile node initiates communication with a PDSN. The PDSN initiates a PMIP registration with a reverse tunneling option with an HA, at step 212. When the reverse tunneling option is enabled a bi-directional tunnel is setup. The PMIP registration in step 212 can include a request, which is a request for addressing information in certain embodiments. The registration with the HA can include an IPv4 Care of Address (CoA) and a request for an IPv6 prefix or Home Address from the HA. The HA assigns first protocol addressing information for the mobile node from a pool of addressing information, at step 214. The pool is added to the HA so the HA can assign a unique IPv6 prefix to MIP sessions in some embodiments. The prefix range is configured as an IPv6 pool within the HA. At step 216, the PDSN receives the addressing information, such as a prefix, and sends a message to the mobile node which includes the addressing information. At step 218, a tunnel is established using first and second protocol information. In some embodiments, the PDSN and HA establish an IPv6-in-IPv4 bi-directional tunnel using a PDSN IPv4 address (this address can also be of a foreign agent), an HA IPv4 address, and an IPv6 address. Packets are forwarded through the tunnel over the second protocol network in step 220.

There are at least two approaches to setting up an IPv6-in-IPv4 tunnel, which depend on how call establishment is handled. In one approach, a single prefix is shared across multiple subscribers or mobile nodes. In the second approach, a unique prefix is assigned per subscriber or mobile node. The approach chosen determines whether the PDSN requests a Home Link prefix or the entire Home Address including the prefix from the HA. Depending on whether a Home Link prefix or a Home Address including the prefix is acquired, determines whether a unique interface identifier is assigned locally by the PDSN or by the HA. The interface identifier can be used along with a prefix to construct a unique IPv6 address. As one practiced in the field would appreciate the mechanism described herein provides the flexibility to adapt any of the approaches provided.

In certain embodiments, the prefix is used by the PDSN along with an interface identifier to construct a unique IPv6 address for the mobile node. The PDSN can generate a local interface identifier for the local side of a PPP link and a remote interface identifier for the mobile node side of the PPP link. If a unique Home Link prefix per session is used, the interface identifier is locally generated and can be unique to the PPP session. In some embodiments, when a unique Home Link prefix per session is used, the Proxy MIP registration can be triggered following the receipt of an IPv6CP configuration-request message. If a shared prefix is used across sessions, the interface identifier is granted by the HA as part of the Home Address. The Proxy registration with a shared prefix is completed before IPv6CP interface identifier negotiation, in certain embodiments. In some embodiments, whether the Home Link prefix or the Home Address is received from the HA, the PDSN can negotiate the interface identifier in IPv6 messaging and send a Home Link prefix in a router advertisement message, and allow the mobile node to compute the global IPv6 Home Address.

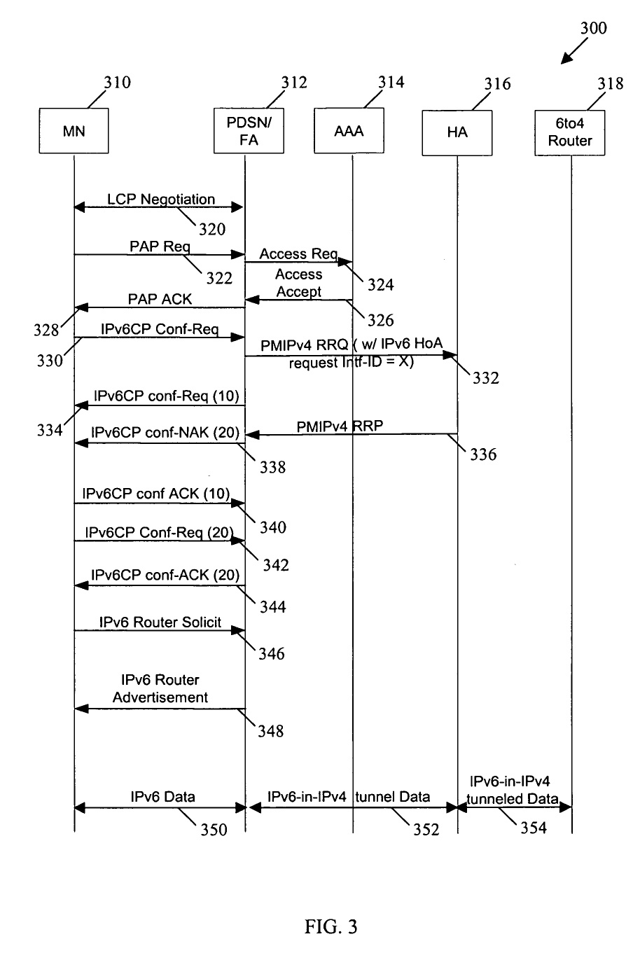

FIG. 3 illustrates a schematic signaling diagram 300 of a tunneling setup with a unique Home Link prefix in accordance with certain embodiments of the present invention. Signaling diagram 300 includes a mobile node 310, a PDSN/FA (Packet Data Serving Node/Foreign Agent) 312, an AAA (Authentication, Authorization, and Accounting) server 314, a HA (Home Agent) 316, and a 6to4 router 318. The call flow illustrated in signaling diagram 300 shows how the PDSN acquires a unique Home Link prefix from the HA for a mobile node and completes a session setup. HA 316 is configured with IPv6 prefix range pools to assign to mobile nodes. Mobile node 310 initiates a session by negotiating a link control protocol (LCP) with PDSN/FA 312 in LCP messaging 320. LCP is a protocol that is used to setup a PPP link. A password authentication protocol (PAP) request message 322 is sent from mobile node 310 to PDSN/FA 312 for a PPP link. Other forms of authentication may be used instead of PAP. PDSN/FA 312 sends an access request message 324 to AAA server 314 to authenticate mobile node 310. An access accept message 326 is sent back to PDSN/FA 312 from AAA server 314 indicating that the mobile node was validated. A password authentication protocol (PAP) acknowledgement (ACK) message 328 is sent to mobile node 310 to indicate to the mobile node that an IPv6 session can be initiated.

Mobile node 310 sends an IPv6CP (Internet Protocol version 6 Control Protocol) configuration-request message 330. IPv6CP is a protocol used for establishing and configuring IPv6 on a PPP link. IPv6CP message 330 can include an interface identifier of 0. The interface identifier of 0 indicates a request to receive an interface identifier. PDSN/FA 312 sends a proxy mobile IP registration-request message (PMIP RRQ) 332 to request a Home Link prefix from HA 316. Because the interface identifier is going to be supplied by PDSN/FA 312, no interface identifier is requested from HA 316, and interface identifier negotiation can begin before a response is received from HA 316. Interface identifier negotiation begins with IPv6CP configuration-request message 334.

The interface identifier negotiation process determines the interface identifier for mobile node 310 and PDSN/FA 312. In IPv6CP configuration-request message 334 PDSN/FA requests an interface identifier (e.g., 10). A PMIP registration-reply message 336, which includes a Home Link prefix is received by PDSN/FA 316. The Home Link prefix can be stored until it is needed for use in router advertisement. Interface identifier negotiation continues with PDSN negatively acknowledging (NAK) in configuration-NAK message 338 the interface identifier chosen by mobile node 310 in configuration-request message 330. IPv6CP configuration-NAK message 338 further suggests an interface identifier for mobile node 310 (e.g., 20). Mobile node 310 accepts the interface identifier chosen by PDSN/FA 312 in configuration-request message 334 in an IPv6CP configuration ACK message 340. Acting on information received in configuration-NAK message 338, mobile node 310 sends a configuration-request message asking for the interface identifier suggested (e.g., 20). PDSN/FA 312 acknowledges the choice in message 344. Mobile node 310 then asks for an IP address, Home Link prefix, or other address identifying information with an IPv6 router solicit message 346. Illustrated PDSN/FA 312 forwards the prefix or other address identifying information received from HA 316 in PMIP registration reply message 336 in an IPv6 router advertisement message 348. Mobile node 310 can use the information (e.g., Home Link prefix) received in router advertisement message 348 along with the interface identifier to construct an IPv6 address. The IPv6 address constructed can be globally unique.

Mobile node begins exchanging IPv6 data packets in messaging 350. When the IPv6 data packets are received by PDSN/FA 312, the IPv6 data packets are encapsulated into PMIP data packets and are forwarded to HA 316 in IPv6-in-IPv4 tunnel 352. In some embodiments, IPv6-in-IPv4 tunnel 352 is unique to the Home Link prefix or the IPv6 address, so the tunnel only carries data packets originating from one mobile node. When HA 316 receives the PMIP data packets HA 316 strips the outer header and forwards the packet over a 6to4 tunnel 354 to 6to4 router 318. Illustrated 6to4 tunnel 354 is a static tunnel in some embodiments, that is, the endpoints of the tunnel are fixed. Further, 6to4 tunnel 354 may carry IPv6 data packets from more than one mobile node.

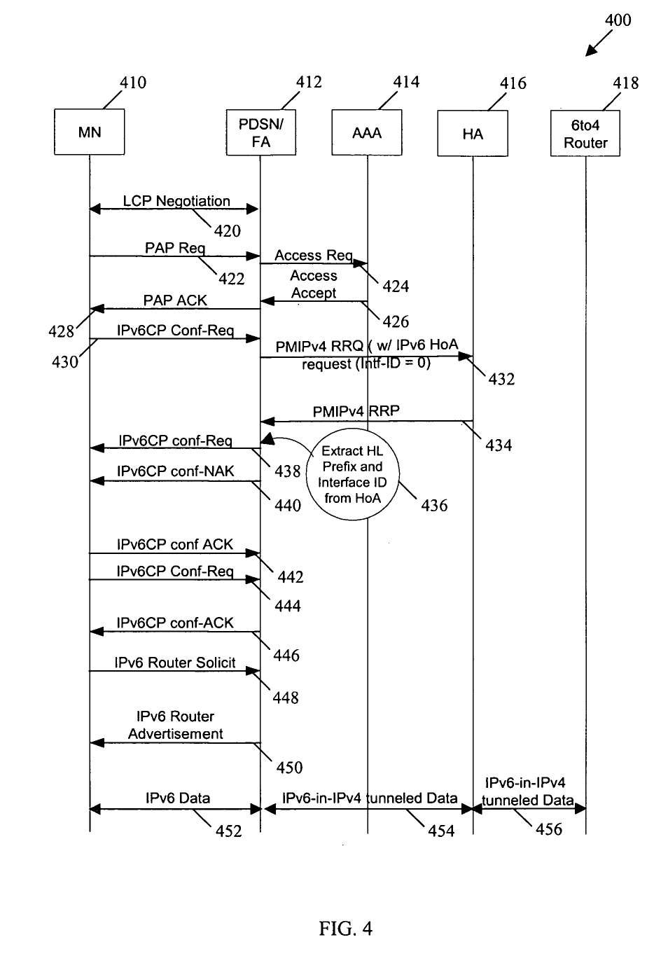

FIG. 4 illustrates a schematic signaling diagram 400 of a tunneling setup with a Home Address in accordance with certain embodiments of the present invention. Signaling diagram 400 includes a mobile node 410, a PDSN/FA 412, an AAA server 414, a HA 416, and a 6to4 router 418. The call flow illustrated in signaling diagram 400 shows how a PDSN acquires an IPv6 Home Address from the HA for assignment to a mobile node and completes a session setup. HA 416 can be configured with IPv6 address pools to assign addresses to mobile nodes. If a prefix is shared across sessions, the interface identifier can be granted by HA 416 as part of the Home Address. PDSN/FA 412 can extract the interface identifier from the Home Address and may wait until PMIP registration has completed before beginning IPv6CP interface identifier negotiation.

Mobile node 410 initiates a session by setting up a PPP link through LCP negotiation 420. In LCP negotiation, the integrity of the link is tested from each link end with LCP packets. Once a PPP link is established, a PAP request 422 is sent to PDSN/FA 412 to authenticate mobile node 410. Illustrated PDSN/FA 412 sends an access request 424 to AAA server 414 to authenticate and otherwise validate mobile node 410. AAA server 414 sends an access accept message 426 to indicate mobile node 410 was successfully authenticated. PDSN/FA 412 sends a PAP ACK 428 to acknowledge that a network layer protocol, such as IPv6, can now be established. Mobile node 410 sends an IPv6CP configuration-request 430 to PDSN/FA 412. Message 430 can include an interface identifier request (e.g., by sending a value of 0) or can provide an interface identifier that mobile node 410 wants to use. PDSN/FA sends a PMIP registration-request 432 that also includes an interface identifier request (e.g., the interface-ID is set equal to 0). HA 416 looks up a prefix to assign from a prefix pool and sends a PMIP registration-reply 434 to PDSN/FA 412. PDSN/FA 412 extracts the Home Link prefix and interface identifier from the Home Address in 436, which was sent from HA 416 in PMIP registration-reply 434.

When PDSN/FA 412 has extracted the Home Link prefix and interface identifier from the Home Address at 436, PDSN/FA 412 requests the extracted interface identifier be used by mobile node 410 in an IPv6CP configuration-request message 438. PDSN/FA 412 also rejects the interface identifier requested in message 430 by sending an IPv6CP configuration-NAK message 440. A suggested interface identifier can be included in the configuration-NAK message 440. The interface identifiers sent in message 438 is accepted in message 442. An interface identifier for mobile node 410 is requested in an IPv6CP configuration-request message 444. PDSN/FA 412 accepts the interface identifier in an IPv6CP configuration-ACK message 446. When mobile node 410 is ready to bring up an IP session, mobile node 410 sends a router solicit message 448 requesting an IP address information. A router advertisement message 450 is sent in response and includes an IP address or Home Link prefix for mobile node 410. IPv6 data messaging is exchanged 452 after an IP address or Home Link prefix is obtained. The configuration information from the setup is used to setup a dynamic IPv6-in-IPv4 tunnel 454 over an IPv4 network. IPv6-in-IPv4 tunnel 454 carries encapsulated data packets, which are decapsulated at the endpoints of the tunnel and then routed based on the decapsulated data packet. HA 416 uses another tunnel 456 to connect to a router 418.

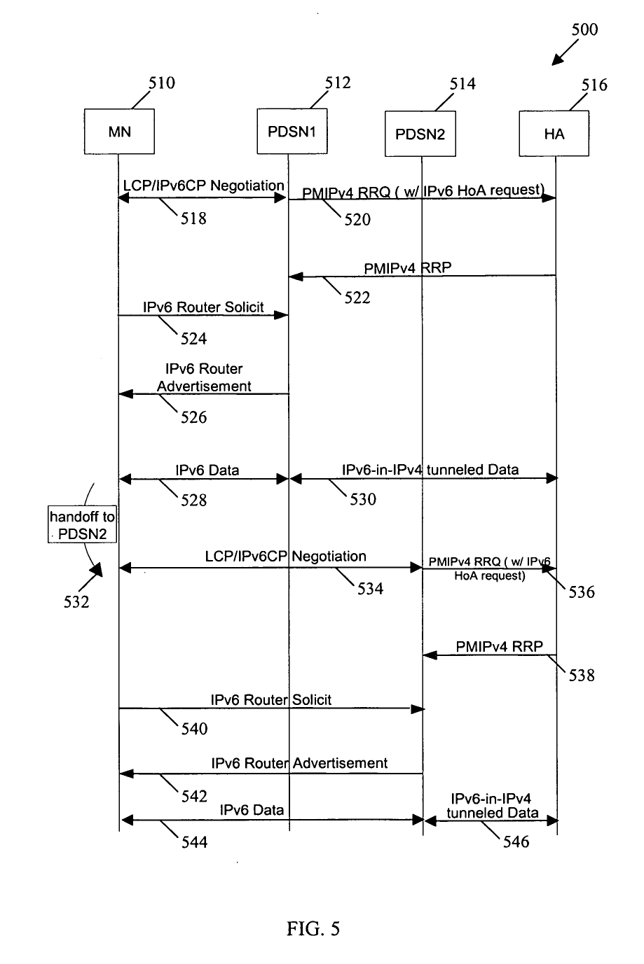

FIG. 5 illustrates the signaling involved in an inter-PDSN handoff 500 in accordance with certain embodiments of the invention. An inter-PDSN handoff maintains a mobile node's IP address as assigned from a Home Agent (HA). Inter-PDSN handoff 500 includes a mobile node 510, a PDSN1 512, a PDSN2 514, and a HA 516. Illustrated mobile node 510 initiates a session through LCP message negotiation to setup a PPP link and IPv6CP messaging to negotiate interface identifiers in messaging 518. When PDSN1 512 detects a mobile node 510 initiating an IPv6 or MIPv6 session over an IPv4 network a PMIPv4 registration-request message 520 is sent to HA 516. HA 516 sends a PMIPv4 registration-reply message 522 to PDSN1 512 which includes either a Home Link or a Home Address for mobile node 510. Other information may also be included, for example when a MIPv6 session is being attempted. Mobile node 510 sends a router solicit message 524 to obtain an IPv6 address or to obtain information to create an IP address. Illustrated PDSN1 512 responds with an IPv6 router advertisement message 526 that can include at least one of an IP address, a Home Address, a Home Link prefix, and other information to construct an IP address. IPv6 data exchange 528 is tunneled through an IPv6-in-IPv4 tunnel 530, which is setup between PDSN1 512 and HA 516. IPv6-in-IPv4 tunnel endpoints are dynamic in some embodiments. For example, the tunnel follows the mobile node through handoffs and the mobile node maintains the IP address assigned by HA 516. The IP address assigned by HA 516 can be an IP address greater than 32 bits even though HA 516 is coupled to a core network that uses only 32 bit addressing.

A handoff to PDSN2 514 occurs at 532. Mobile node 510 negotiates LCP and IPv6CP information in messaging 534. A PMIPv4 registration-request message 536 is sent from PDSN2 514 to HA 516. A PMIPv4 registration-reply 538 is sent from HA 516 to PDSN2 514 which includes information to setup an IP session with mobile node 510 and an IPv6-in-IPv4 tunnel 546. An IPv6 router solicit message 540 is sent from mobile node 510 to PDSN2 514 to obtain an IP address or information to construct an IP address such as a Home Link prefix. An IPv6 router advertisement message 542 is sent from PDSN2 514 to mobile node 510 which includes information for mobile node 510 to setup an IPv6 or MIPv6 session. IPv6 packet data flows between mobile node 510 and PDSN2 514 in messaging 544. An IPv6-in IPv4 tunnel 546 is setup to transport IPv6 data over an IPv4 network. Illustrated IPv6-in-IPv4 tunnel 546 uses the same IP address for mobile node 510 as IPv6-in-IPv4 tunnel 530.

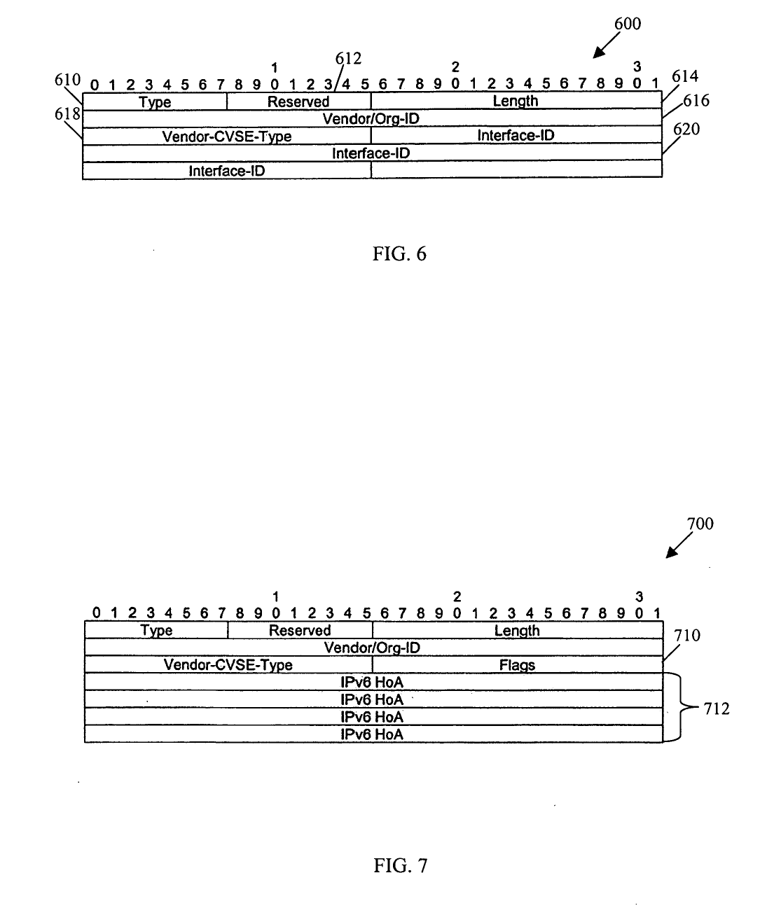

FIG. 6 illustrates an IPv6 Home Address request extension message 600 that is used to request a Home Link prefix or Home Address from an HA in certain embodiments of the invention. IPv6 Home Address request extension message 600 includes a type field 610, a reserved field 612, a length field 614, and a Vendor/Organization ID field 616. Type field 610 indicates the kind of extension message and can take a value such as 38. Reserved field 612 indicates that this bit space is saved for future use. In some embodiments, information can be placed in this field and the reserved status removed. Length field 614 indicates the length of the extension message, for example, 16 bytes. Vendor/Organization ID field 616 indicates the Vendor using the extension message, such as Starent Networks/8164. The IPv6 Home Address extension message 600 can be included by the PDSN in initial registration-request messages sent to the HA in some embodiments. When the PDSN has locally assigned an interface identifier to the mobile node or subscriber session, the PDSN can include a non-zero interface identifier in this extension to request the HA assign a unique Home Link prefix. If the PDSN expects the HA to assign a Home Address including an interface identifier, then PDSN can set the interface identifier to zero.

Illustrated IPv6 Home Address request extension message 600 can be formed using a Mobile IP critical vendor-specific extension (CVSE) and setting the vendor-CVSE-type field to include an IPv6 Home Address request type and the vendor-CVSE-value to include the interface identifier. In some embodiments, a PPP username can be used as a network address identifier (NAI) for the PMIP session and sent in the mobile node-NAI (MN-NAI) extension. If a PPP username is not available, then another identifier may be needed to identify the session. A mobile node ID (MNID) may be used to identify the session and this can be carried in the mobile node-NAI (MN-NAI) extension or a new vendor-specific extension.

FIG. 7 illustrates an IPv6 Home Address extension message 700 that sends a Home Address and a unique Home Link prefix in accordance with certain embodiments of the invention. Illustrated IPv6 Home Address extension message 700 may be included in a registration-request from the PDSN or a registration-reply from the HA to identify a MIP registration or a MIP revocation and any corresponding acknowledgement messages. A CVSE can be used to form IPv6 Home Address extension message 700. The CVSE can be modified with the vendor-CVSE-type being used for providing an IPv6 Home Address and the vendor-CVSE-value including flags field 710 and IPv6 Home Address field 712. Flags filed 710 can include Home Link prefix and IPv6 Home Address field 712 can include a 128 bit address or any address greater than 32 bits.

For a mobile node that was assigned an IPv6 Home Address though PMIP, the PMIP registration-request from the PDSN may include extension messages 600 and 700 depending on the type of request. IPv6 Home Address request extension message 600 can be included in the initial registration-request from the PDSN to the HA for call setup. IPv6 Home Address extension message 700 can be included in renewal and deregistration requests from the PDSN to the HA as well as registration reply messages from the HA. In some embodiments, IPv6 Home Address request extension message 600 and IPv6 Home Address extension message 700 are included before the foreign agent-home agent (FA-HA) authentication extension. The IPv6 Home Address extension message 700 can be included in MIP registration revocation and revocation acknowledgement messages from PDSN or HA to identify the MIP registration.

The PDSN can have a role in IPv6 addressing, mobile node authentication, and IPv6 data processing. If the mobile node is to be assigned a unique Home Link prefix, the PDSN assigns an interface identifier locally and initiates PMIP to the HA. The PDSN sends a registration-request to the HA including the IPv6 Home Address request extension 600 with the interface identifier set to the assigned interface identifier. After receiving the assigned interface identifier, the HA sends a unique Home Link prefix to the PDSN. If the mobile node does not need a unique Home Link prefix, the PDSN can initiate PMIP to the HA when an IPCP configuration request message is received. The PDSN sends a registration request to the HA including the IPv6 Home Address request extension message 600 with the interface identifier set to zero. When an accepted registration reply with an IPv6 Home Address extension message 600 is received with a valid home address, the PDSN can extract the Home Link prefix and interface identifier from the Home Address. The PDSN passes the address information to the mobile node via a router advertisement message and puts the subscriber in a connected state.

PDSN authentication includes a PPP challenge-handshake authentication protocol (CHAP) or a password authentication protocol (PAP) in certain embodiments. If there is no key distribution scheme implemented at the PDSN during a PMIP setup, mobile node-HA (MN-HA) and mobile node-AAA (MN-AAA) authentication extensions may not be included in the registration request. In some embodiments, when a PDSN receives an IPv6 packet data unit over a PPP session from a mobile node and a PMIP tunnel has been established, the PDSN encapsulates the packet in an IPv4 packet and forwards the packet to the HA. If the PDSN receives an IPv4 encapsulated IPv6 packet data unit from the HA over the PMIP tunnel, the PDSN removes the outer IPv4 header and forwards the IPv6 packet data unit over the PPP session to the mobile node.

The HA can have a role in IPv6 addressing, mobile node authentication, and IPv6 data processing. In order to fulfill requests, the HA is configured with IPv6 prefix pools or IPv6 address pools in some embodiments. Other addressing schemes employing more than 32 bits can also be used. If an interface identifier is assigned at the PDSN, the HA assigns a unique Home Link prefix per mobile node. When a registration request is received with an IPv6 Home Address request 600 that has a non-zero interface identifier in it, the HA assigns a Home Link prefix to the mobile node, forms the global IPv6 address for the mobile node using the interface identifier, and sends a reply that includes a Home Address extension message 700. When a registration request is received with the interface identifier set to zero in an IPv6 Home Address request extension message 600, the HA assigns an IPv6 Home Address to the mobile node and sends a reply with an IPv6 Home Address extension message 700. If the interface identifier is assigned at the HA, the HA can choose to assign a shared or unique Home Link prefix per mobile node. If a unique Home Link prefix is sent, a unique Home Link prefix flag in the Home Address extension message can indicate this. In certain embodiments, the HA provides IPv6 services to a roaming mobile node over an IPv4 network through a PMIP tunnel.

When the HA receives an IPv6 packet data unit over a 6to4 tunnel from the 6to4 router, the HA removes the IPv4 header and looks at the inner IPv6 address. If a PMIP tunnel has been established for the mobile node with this inner IPv6 address, the HA encapsulates the packet with addressing greater than 32 bits in an IPv4 packet and forwards the IPv4 packet to the PDSN. If the HA receives an IPv4 encapsulated IPv6 packet data unit from the PDSN over the PMIP tunnel, the HA removes the outer IPv4 header and forwards the IPv6 packet data unit over the 6to4 tunnel to the 6to4 router.

In some embodiments, protocols such as MIPv6 are supported over an IPv4 core network. When the PDSN detects that a MIPv6 session is being negotiated, a PMIP registration request can be sent to the HA to setup a tunnel. The MIPv6 session can be detected by looking for IPSec negotiation or Internet Control Messaging Protocol (ICMP) prefix solicitation. MIPv6 may use a different interface identifier such as a mobile node-network access identifier (MN-NAI), a fully qualified domain name (FQDN), an international mobile station identifier (IMSI), and a mobile subscriber number. The prefix assignment for protocols other than IPv6 can be handled in a similar fashion as explained above, and the PDSN can automatically detect and encapsulate packets for transfer in a PMIP tunnel. The PDSN can detect packets by inspecting the packet header information and applying rules. The rules can take an if/then format so if a condition is found, the corresponding action is performed.

In certain embodiments, a PMIP tunnel is applied in situations where packet data transmissions are routed directly from a mobile node to a correspondent node. This can occur, for example, in MIPv6 using a route optimization mode where the mobile node registers its current binding (a binding is the relationship between a home address and a care-of address) at the correspondent node. In embodiments supporting route optimization, a router coupled to an IPv4 core network can setup a PMIP tunnel to the PDSN for carrying packet data traffic over an IPv4 network. The PMIP tunnel can be dynamic so that the tunnel can move with binding updates to other PDSNs.

As one practiced in the field would appreciate, using a protocol such as PMIP within a network can be used in combination with a number of other protocols and other network topologies. Other network topologies that can be used in conjunction with proxy tunneling to provide a mobile node with addressing features over an incompatible network are networks such as WiMax, WiFi, CDMA2000, UMTS, GPRS, and GSM.

In some embodiments, software needed for implementing a process includes a high level procedural or an object-orientated language such as C, C++, C#, Java, or Perl. The software may also be implemented in assembly language if desired. The links or mapping may be implemented by pointers, memory references, or any other applicable method. The database or virtual database may be created by a number of different data structures such as arrays, linked-lists, trees, associative arrays, stacks, and queues. In certain embodiments, the software is stored on a storage medium or device such as read-only memory (ROM), programmable-read-only memory (PROM), or magnetic disk that is readable by a general or special purpose-processing unit to perform the processes described in this document. In some embodiments, a packet data serving node (PDSN), a foreign agent (FA), or home agent (HA) can be implemented on a Starent Networks Corporation of Tewksbury, Mass. ST-16 Intelligent Mobile Gateway. Other types of devices can also be used in other embodiments to setup tunnels such as a Gateway General packet radio service Service Node (GGSN), a serving GPRS support node (SGSN), a session initiation protocol (SIP) server, a proxy-call session control function (P-CSCF), and an interrogating-call session control function (I-CSCF).

Although the present invention has been described and illustrated in the foregoing exemplary embodiments, it is understood that the present disclosure has been made only by way of example, and that numerous changes in the details of implementation of the invention may be made without departing from the spirit and scope of the invention, which is limited only by the claims which follow.

We claim:

1. A packet data communication system comprising:
a packet data serving node (PDSN) that communicates with a mobile node using a first protocol;
a network core that is coupled to the packet data serving node that uses a second protocol;
a home agent (HA) that is coupled to the network core, wherein a tunnel is established between the PDSN and the HA to exchange packet data in a first protocol over a network core that uses a second protocol; and
a second PDSN coupled to the network core, wherein the mobile node maintains the same address when the mobile node moves from the PDSN to the second PDSN.

2. The system of claim 1, wherein the mobile node uses at least one of IPv6 and MIPv6.

3. The system of claim 1, wherein the mobile node is assigned a unique Home Link prefix.

4. The system of claim 1, wherein the PDSN receives a Home Address from the home agent.

5. The system of claim 4, wherein the PDSN extracts a Home Link prefix from the Home Address.

6. The system of claim 1, wherein the PDSN receives an IPv6 packet data unit and the PDSN encapsulates the IPv6 packet in an IPv4 packet and forwards the IPv4 packet to the home agent.

7. The system of claim 1, wherein the PDSN communicates bi-directionally with the home agent using proxy mobile IP (PMIP).

8. The system of claim 1, wherein the home agent keeps a MIP registration binding for an IPv6 Home Address and a foreign agent IPv4 care of address.

9. A packet data communication method comprising:
assigning an address to a mobile node;
establishing a tunnel from a packet data serving node (PDSN) to a home agent to exchange packet data in a first protocol over a network core that uses a second protocol;
assigning the same address to the mobile node when the mobile node moves to a second PDSN and a handoff from the PDSN to the second PDSN occurs; and
establishing the tunnel from the second packet data serving node to the home agent to exchange packet data.

10. The method of claim 9, wherein assigning an address includes using one of IPv6 and MIPv6.

11. The method of claim 9, further comprising assigning a unique Home Link prefix to the mobile node from the home agent.

12. The method of claim 9, further comprising assigning a Home Address from the home agent.

13. The method of claim 12, further comprising extracting a Home Link prefix from the Home Address.

14. The method of claim 9, further comprising:
receiving an IPv6 packet data unit from the mobile node;
encapsulating the IPv6 packet in an IPv4 packet; and
forwarding the IPv4 packet to the home agent.

15. The method of claim 9, wherein establishing the tunnel entails using a bi-directional proxy mobile IP (PMIP) tunnel.

16. The method of claim 9, further comprising storing a MIP registration binding for an IPv6 Home Address and a foreign agent IPv4 care of address on the home agent.

17. A packet data communication system comprising:
means for communicating with a mobile node using a first protocol;
a network core that is coupled to the means for communicating that uses a second protocol;
a means for providing home routing that is coupled to the network core, wherein a tunnel is established between the means for communicating and the means for providing home routing to exchange packet data in a first protocol over a network core that uses a second protocol; and
a second means for communicating coupled to the network core, wherein the mobile node maintains the same address when the mobile node moves from the means for communicating to the second means for communicating.

18. The system of claim 17, wherein the mobile node uses at least one of IPv6 and MIPv6.

19. The system of claim 17, wherein the means for communicating communicates bi-directionally with the means for providing home routing using proxy mobile IP (PMIP).
